(19) United States
(12) Patent Application Publication
(10) Pub. No.: US 2006/0187194 A1
(43) Pub. Date: Aug. 24, 2006

(54) Multimedia player having a detachable display screen

(76) Inventors: Chin-Hin Chong, Penang (MY); Shih-Hsiung Weng, Taipei City (TW)

Correspondence Address: RABIN & Berdo, PC, 1101 14TH STREET, NW, SUITE 500, WASHINGTON, DC, 20005, US

(21) Appl. No.: 11/150,102

(22) Filed: Jun. 13, 2005

(30) Foreign Application Priority Data
Jan. 31, 2005 (TW) 94201778

(51) Int. Cl. G09G 5/00

(52) U.S. Cl. 345/156

(57) ABSTRACT

A multimedia player having a detachable display screen includes a host body and a display panel body. The host body has a first signal transmission port and a coupling slot on one lateral side and the display panel body has a display panel and a connection dock. The coupling slot includes a cavity and a latch trough. The display panel generates pictures according to displaying signals of the host body. The connection dock has a movable latch pin corresponding to the coupling slot. The movable latch pin includes a head. The movable latch pin may be moved to a latched position, so that the head is confined by the latch trough to anchor the display panel body on the host body, and be moved to an unlatched position where the head is removable from the cavity, so that the display panel body may be detached from the host body.

### FIELD OF THE INVENTION The present invention relates to a multimedia player and, in particularly, to a multimedia player having a detachable display screen.

### BACKGROUND OF THE INVENTION

In recent years electronic information technology has made rapid progress, especially in multimedia developments. Now prolific multimedia players have been created and introduced on the market. They are designed in varying playing specifications, such as Lucasfilm THX, Dolby Digital Surround, SRS Circle Surround, Qsurround, and the like. As to the image storage media, the commonly used specifications are VCD and DVD that provide high capacity and high quality of images, and those used in the digital cameras or video cameras for storing image data. They give users pleasure and entertainment.

With advanced developments of semiconductor manufacturing technology, the multimedia players that only could be used in homes or computers in the past for playing high quality music and image data now have been shrunk drastically by adopting modular design. These days, many multimedia players are miniaturized and can be carried around easily.

These small and portable multimedia players enable users to hear and see all kinds of video or audio data, or animation films and movies anytime anywhere. Some even can be connected to external digital cameras and video cameras. They are very convenient.

However, most of the products now on the market have the display screen fixedly coupled on the host body. The display screen cannot be installed and used on other multimedia peripheral devices. Moreover, if the display screen is damaged and needs replacement, the host body also has to be sent for repairing. The host body is not available and not usable in the repairing period.

The aforesaid problems occurring to the conventional techniques or products now on the market are an issue remained to be overcome.

### SUMMARY OF THE INVENTION

In view of the aforesaid problems, the primary object of the present invention is to provide a multimedia player that has a detachable display screen to allow the display screen to be removed from the host body, whenever desired.

Another object of the invention is to provide a multimedia player that has a detachable display screen, usable by many other types of multimedia players.

The multimedia player, having a detachable display screen according to the invention, consists of a host body and a display panel body. The host body has a first signal transmission port and a coupling slot on one side. The coupling slot includes a cavity and a latch trough that communicate with each other. The latch trough has a smaller size than the cavity. The display panel body includes a display panel and a connection dock. The connection dock has a second signal transmission port corresponding to the first signal transmission port, to enable the display panel to generate pictures according to the displaying signals of the host body. The connection dock has a movable latch pin corresponding to the coupling slot. The latch pin includes a head and a neck that are connected to each other. The head is larger than the latch trough, but smaller than the cavity.

The movable latch pin has a latched position and an unlatched position. When the movable pin is located on the latched position, the head is confined by the latch trough, to anchor the display panel body on the host body. When the movable latch pin is on the unlatched position, the head may be inserted into or removed from the cavity, to disengage the display panel body with the host body.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the multimedia player having a detachable display screen of the invention.

FIG. 2A is an exploded view of the display panel body of the invention.

FIG. 2B is a perspective view of the movable latch pin of the invention.

FIG. 2C is another perspective view of the movable latch pin of the invention.

FIG. 3 is a schematic view of the invention with the movable latch pin on a latched position.

FIG. 4 is a schematic view of the invention with the movable latch pin on an unlatched position.

### DESCRIPTION OF THE PREFERRED EMBODIMENT

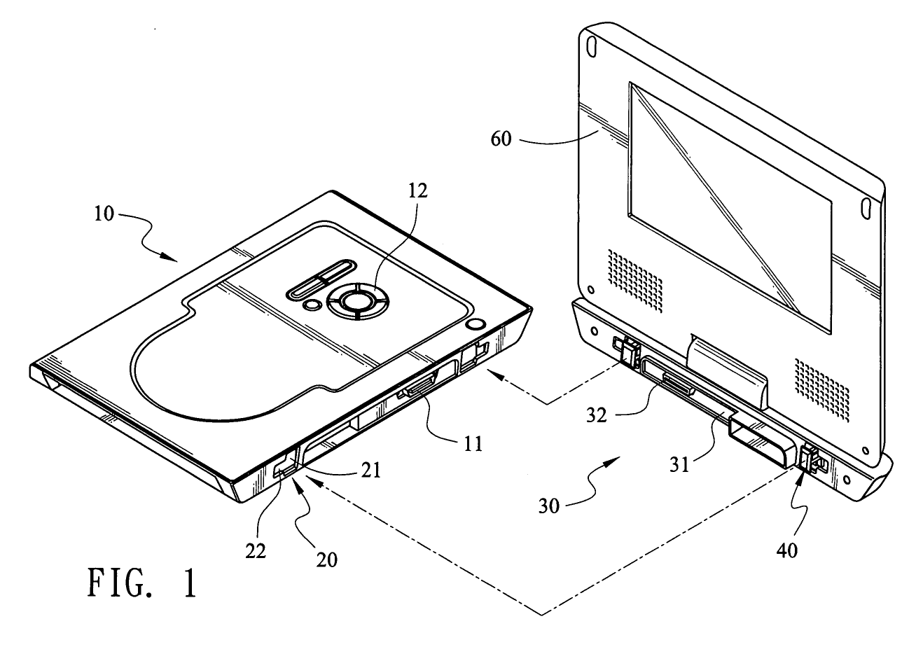

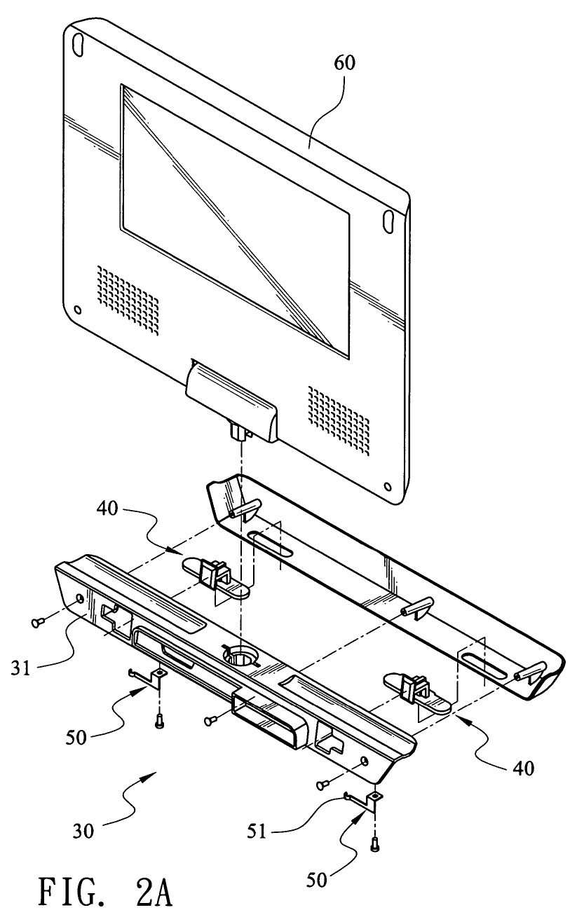

Referring to FIGS. 1 through 4, the multimedia player, having a detachable display screen according to the invention, mainly includes a host body 10 and a display panel body 30. The host body 10 has a plurality of control buttons 12 on the topside for user operation and a coupling slot 20 on one lateral side. The coupling slot 20 includes a cavity 21 and a latch trough 22 that communicate with each other. The latch trough 22 is smaller than the cavity 21. The host body 10, further, has a first signal transmission port 11 on the lateral side where the coupling slot 20 is formed to transmit displaying signals to the display panel body 30.

The display panel body 30 includes a connection dock 31 and a display panel 60, which is hinged on the connection dock 31. When the display panel body 30 is coupled on the host body 10, the display panel 60 can be folded over the host body 10. The connection dock 31 has a second signal transmission port 32 on one lateral side, corresponding to the first signal transmission port 32 to receive the displaying signals, so that the display panel 60 can generate pictures according to the displaying signals. The connection dock 31 has a movable pin 40 on the same side of the second signal transmission port 32. The movable pin 40 has a head 41 connecting to a neck 42, and a moving section 44. The head 41 has a cross section larger than the neck 42. The head 41 also is larger than the latch trough 22, but is smaller than the cavity 21. The neck 42 is slightly smaller than the latch trough 22.

The moving section 44 is exposed outside the connection dock 31, and has a plurality of ridges to receive a pushing force from a user. There is a retaining element 50 formed by an elastic elongate plate. The retaining element 50 has an extended latch section 51 corresponding to a notch 43 formed on the movable pin 40.

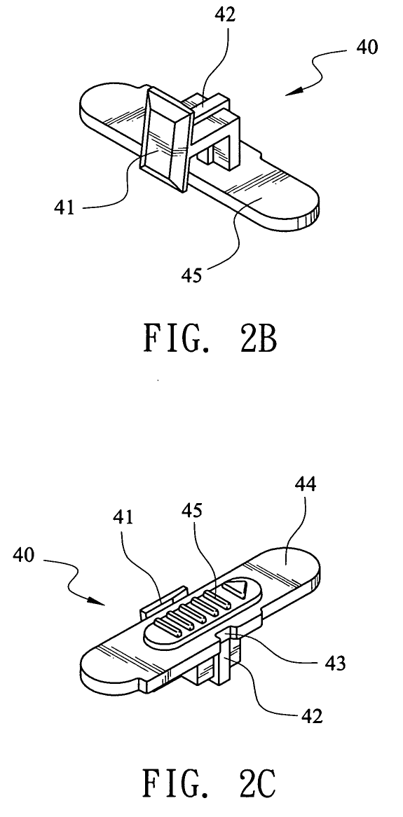

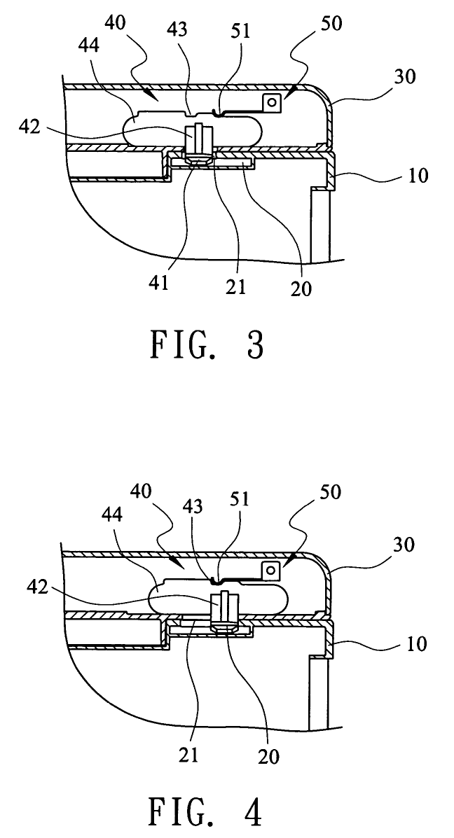

The movable pin 40 may be switched between a latched position as shown in FIG. 3, and an unlatched position as shown in FIG. 4. When the movable latch pin 40 is moved to the latched position, the neck 42 slides into the latch trough 22 and the head 42 is confined by the latch trough 22 because of its larger size than the latch trough 22, so that the display panel body 30 is coupled on the host body 10. Moreover, the latch section 51 of the retaining element 50 is engaged with the notch 43 of the movable pin 40, to hold the movable pin 40 on the latched position in normal condition.

A user can push the moving section 44 in one direction to change the movable pin 40 to the unlatched position as shown in FIG. 4. The movable pin 40 may be moved under a force, so that the notch 43 escapes the latch section 51, and the movable pin 40 is moved to the unlatched position. As the head 41 is smaller than the cavity 21, it can be separated therefrom. Hence the display panel body 30 may be removed from the host body 10.

In the conventional multimedia player, the display screen and the host body cannot be separated. Hence when the display screen is damaged and requires repair, the host body also has to be sent together for repairing and becomes useless. By means of the invention, the display panel body 30 is movably coupled on the host body 10, and can be detached as desired. Hence the host body 10 can function as desired in normal condition. If damage occurs to the host body 10, the display panel body 30 may be removed and used on other devices.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. A multimedia player having a detachable display screen, comprising:
a host body having a first signal transmission port and a coupling slot on one lateral side, the coupling slot including a cavity and a latch trough communicating with each other, the latch trough being smaller than the cavity; and
a display panel body having a display panel and a connection dock, the connection dock including a second signal transmission port corresponding to the first signal transmission port, the display panel generating pictures according to displaying signals of the host body, the connection dock having a movable latch pin corresponding to the coupling slot, the movable latch pin including a head and a neck, the head being larger than the latch trough and smaller than the cavity;
wherein the movable latch pin is movable to a latched position where the head is confined by the latch trough such that the display panel body is anchored on the host body and a unlatched position where the head is removable from the cavity such that the display panel body is detachable from the host body.

2. The multimedia player of claim 1, wherein the display panel body further has a retaining element, and the movable latch pin has a corresponding notch to engage with the retaining element to anchor the movable latch pin on the latched position in normal conditions.

3. The multimedia player of claim 1, wherein the movable latch pin has a moving section to receive a force from users.

4. The multimedia player of claim 3, wherein the moving section is exposed outside a bottom side of the connection dock.

5. The multimedia player of claim 4, wherein the moving section has a plurality of ridges to receive the force of the users.

6. The multimedia player of claim 1, wherein the first signal transmission port is located on the same lateral side of the host body where the coupling slot is located.

7. The multimedia player of claim 1, wherein the display panel is coupled on the connection dock in a swivelable manner.

8. The multimedia player of claim 1, wherein the host body has a plurality of control buttons on a top side for user operation.
